(19) United States
(12) Patent Application Publication
(10) Pub. No.: US 2020/0167025 A1
(43) Pub. Date: May 28, 2020

(54) FLEXIBLE TOUCH COVER AND OUT-CELL TYPE FLEXIBLE TOUCH DISPLAY PANEL

(71) Applicant: Wuhan China Star Optoelectronics Technology Co., Ltd., Wuhan (CN)

(72) Inventor: Shiyuan XIAO, Wuhan (CN)

(73) Assignee: Wuhan China Star Optoelectronics Technology Co., Ltd., Wuhan (CN)

(21) Appl. No.: 16/470,216

(22) PCT Filed: Nov. 26, 2018
(86) PCT No.: PCT/CN2018/117360

§ 371 Date: Jun. 16, 2019

(30) Foreign Application Priority Data
Sep. 29, 2018 (CN) 201811144234.8

(51) Int. Cl. G06F 3/041; G09F 9/30

(52) U.S. Cl. CPC G06F 3/0412; G06F 2203/04102; G09F 9/301

(57) ABSTRACT

A flexible touch cover and an out-cell type flexible touch display panel are provided, the flexible touch cover is used for the out-cell type flexible touch display panel. The flexible touch cover includes a base layer including a first surface and a second surface opposite to the first surface, a hardened layer disposed on the first surface, and a touch control layer disposed on the second surface. A thickness of the out-cell type flexible touch display panel can be reduced, and the out-cell type flexible touch display panel also has excellent anti-interference.

### FIELD OF INVENTION

The present invention relates to a field of display technologies, and more particularly, to a flexible touch cover and an out-cell type flexible touch display panel.

### BACKGROUND OF INVENTION

With development of touch technology, there are an increasing number of fields that touch displays applied to. Among them, more out-cell type touch display panels have been applied because of their excellent anti-interference. As shown in FIG. 1, in a current out-cell type touch display panel 100, first, sensors are disposed on a rigid substrate, such as glass, to construct a sensing substrate 130. Next, the sensing substrate is fixedly attached to a flexible display panel 150 by an adhesive layer 140. In addition, a rigid cover 110, such as glass, is fixedly attached to another surface of the sensing substrate 130 by the use of another adhesive layer 140 to protect the sensing substrate 130 and the flexible display panel 150.

However, because of the need of the rigid cover 110 and the rigid sensing substrate 130 in the existing out-cell type touch display panel, it is hard to fold the existing out-cell type touch display panel. Furthermore, the rigid cover 110 and the sensing substrate 130 have a certain thickness, respectively, and two adhesive layers 120 and 140 are needed for fixedly assembling, so that it is hard to further reduce the thickness of the existing out-cell type touch display panel.

Therefore, it is necessary to provide a flexible touch cover and an out-cell type flexible touch display panel to solve the problems of the prior art.

### SUMMARY OF INVENTION

The object of the present invention provides a flexible touch cover and an out-cell type flexible touch display panel, which have beneficial effects, such as excellent anti-interference, foldable property, and thinner thickness, to solve the problems of the prior art.

In order to achieve the aforementioned objects of the present invention, the present invention provides a flexible touch cover for an out-cell type flexible touch display panel, comprising:

a base layer having a first surface and a second surface opposite to the first surface, the base layer comprising polyimide;

a hardened layer disposed on the first surface; and

a touch control layer disposed on the second surface.

In one embodiment of the present invention, the touch control layer comprises at least one sensor.

In one embodiment of the present invention, the flexible touch cover further comprises an adhesive layer configured to fixedly assemble the flexible touch cover in the out-cell type flexible touch display panel.

In one embodiment of the present invention, the hardened layer comprises a resin material.

In one embodiment of the present invention, the hardened layer comprises silicon dioxide or titanium dioxide.

The present invention further provides a flexible touch cover for an out-cell type flexible touch display panel, comprising:

a base layer having a first surface and a second surface opposite to the first surface;

a hardened layer disposed on the first surface; and

a touch control layer disposed on the second surface.

In one embodiment of the present invention, the base layer is transparent and foldable.

In one embodiment of the present invention, the base layer comprises polyimide.

In one embodiment of the present invention, the touch control layer comprises at least one sensor.

In one embodiment of the present invention, the flexible touch cover further comprises an adhesive layer configured to fixedly assemble the flexible touch cover in the out-cell type flexible touch display panel.

In one embodiment of the present invention, the hardened layer comprises a resin material.

In one embodiment of the present invention, the hardened layer comprises silicon dioxide or titanium dioxide.

The present invention further provides an out-cell type flexible touch display panel, comprising:

a flexible display panel;

an adhesive layer disposed in the flexible display panel; and

a flexible touch cover disposed on the adhesive layer, the flexible touch cover fixedly assembled with the flexible display panel by the adhesive layer, wherein the flexible touch panel comprises:

a base layer having a first surface and a second surface opposite to the first surface;

a hardened layer disposed on the first surface away from the flexible display panel; and

a touch control layer disposed on the second surface facing the flexible display panel.

In one embodiment of the present invention, the base layer is transparent and foldable.

In one embodiment of the present invention, the base layer comprises polyimide.

In one embodiment of the present invention, the touch control layer is adjacent to the adhesive layer, such that the flexible touch cover is fixed on the flexible display panel.

In one embodiment of the present invention, the hardened layer is configured to protect the base layer from being scratched.

In one embodiment of the present invention, the hardened layer comprises a resin material.

In one embodiment of the present invention, the hardened layer comprises silicon dioxide or titanium dioxide.

In one embodiment of the present invention, the touch control layer comprises at least one sensor.

The beneficial effect: the rigid cover and the sensing substrate in the prior art can be replaced by using the flexible touch cover, such that the out-cell type flexible touch display panel can have excellent anti-interference and foldable property. In addition, the thickness occupied by the rigid cover and the sensing substrate can be reduced and the number of the used adhesive layer can be reduced, so as to the thickness of the out-cell type flexible touch display panel can be further reduced.

### DESCRIPTION OF DRAWINGS

In order to more clearly illustrate the technical solutions in the embodiments or the prior art, the following drawings, which are intended to be used in the description of the embodiments or the prior art, will be briefly described. It will be apparent that the drawings and the following description are only some embodiments of the present invention. Those of ordinary skill in the art may, without creative efforts, derive other drawings from these drawings.

FIG. 1 is a schematic structural view of an existing out-cell type touch display panel.

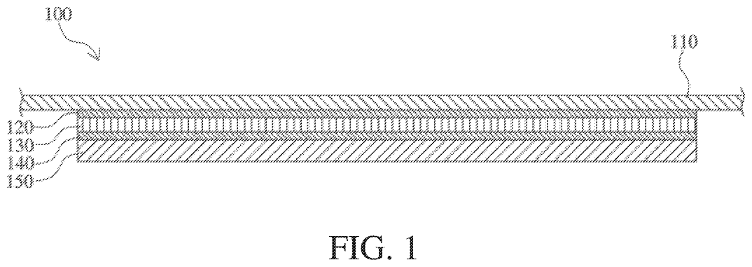

FIG. 2 is a schematic structural view of a flexible touch cover of the present invention.

FIG. 3 is a schematic structural view of an out-cell type flexible touch display panel of the present invention.

4 is a schematic structural view of an out-cell type flexible touch display panel of the present invention in a folding state.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, “left”, “right”, “inside”, “outside”, “side”, etc., is used with reference to the orientation of the figure(s) being described. As such, the directional terminology is used for purposes of illustration and is in no way limiting. Throughout this specification and in the drawings like parts will be referred to by the same reference numerals.

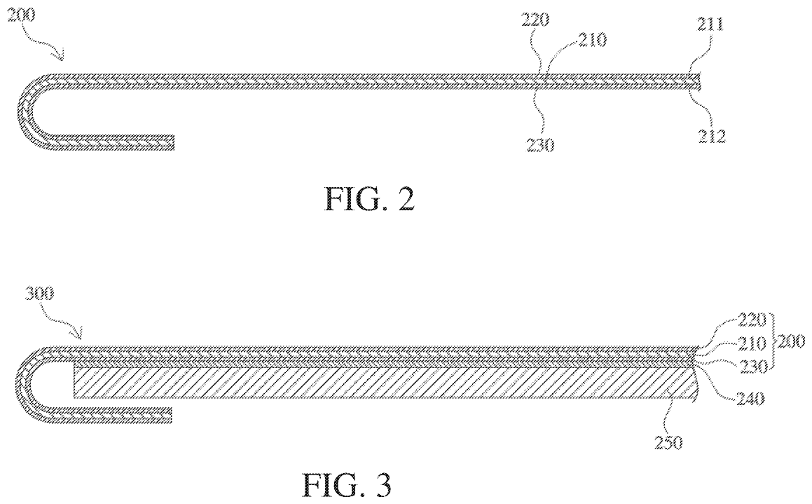

As shown in FIG. 2, the present invention provides a flexible touch cover 200 for an out-cell type flexible touch display panel, the flexible touch cover 200 includes a base layer 210, a hardened layer 220, and a touch control layer 230. The base layer 210 has a first surface 211 and a second surface 212 opposite to the first surface 211. The hardened layer 220 is disposed on the first surface 211. The touch control layer 230 is disposed on the second surface 212.

The base layer 210 is transparent and foldable. The base layer 210 may include polyimide (PI), or other material with properties of being transparent and foldable.

The touch control layer 230 includes at least one sensor to implement a touch control function. The sensor may be disposed on the touch control layer 230 in an array. The sensor may be a capacitive sensor, and the sensor may be replaced with a resistive sensor or a sensor which operates in other forms and has a touch control function. The sensor may be formed by a two-layered metal mesh. The fabrication of the metal mesh may require processes, such as metal deposition, exposure, development, etching, stripping, and water cleaning between thereof. It should be noted that the metal mesh may also be replaced with other conductive materials, such as indium tin oxide (ITO). It should be noted that the person skilled in the art may use other processes to form a sensor with a touch function as the touch control layer 230.

The hardened layer 220 is configured to protect the base layer 210 from being scratched during use (such as touching). The hardened layer may include a resin material, a silicon dioxide, or titanium dioxide. The hardened layer 220 may be uniformly disposed on the first surface 211 by a spraying technique or a sputtering technique. It should be noted that, for the person skilled in the art, the harden layer 220 may further be disposed on the first surface 211 by a depositing technique or a coating technique.

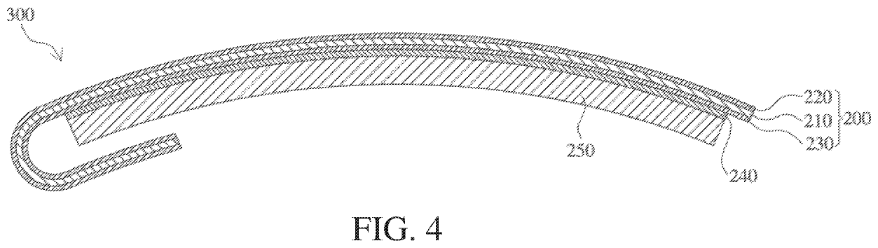

The flexible touch cover 200 further includes an adhesive layer 240 configured to fixedly assemble the flexible touch cover 200 in the out-cell type flexible touch display panel 300. Referring to FIG. 3, the adhesive layer 240 is disposed between the flexible display panel 250 and the flexible touch cover 200, and the adhesive layer 240 connects the flexible display panel 250 and the touch control layer 230. Therefore, the flexible touch cover 200 is fixedly assembled in the out-cell type flexible touch display panel 300.

As shown in FIG. 3, the present invention further provides an out-cell type flexible touch display panel 300, the out-cell type flexible touch display panel 300 includes a flexible display panel 250, an adhesive layer 240, and a flexible touch cover 200. The adhesive layer 240 is disposed on the flexible display panel 250. The flexible touch cover 200 is disposed on the adhesive layer 240. The flexible touch cover 200 is fixedly assembled with the flexible display panel 250 by the adhesive layer 240, so as to form the out-cell type flexible touch display panel 300.

The flexible touch cover 200 includes a base layer 210, a hardened layer 220, and a touch control layer 230. The base layer 210 has a first surface 211 and a second surface 212 opposite to the first surface 211.

The hardened layer 220 is disposed on the first surface 211 away from the flexible display panel 250. The touch control layer 230 is disposed on the second surface 212 facing the flexible display panel 250.

The base layer 210 is transparent and foldable. The base layer 210 may include polyimide (PI), or other material with properties of being transparent and foldable.

The touch control layer 230 is adjacent to the adhesive layer 240, such that the flexible touch cover 200 is fixed on the flexible display panel 250.

The hardened layer 220 is configured to protect the base layer 210 from being scratched. The hardened layer 220 may include a resin material. The hardened layer may also include silicon dioxide or titanium dioxide. The hardened layer 220 may be uniformly disposed on the first surface 211 by a spraying technique or a sputtering technique. It should be noted that, for the person skilled in the art, the harden layer 220 may further be disposed on the first surface 211 by a depositing technique or a coating technique.

The touch control layer 230 includes at least one sensor to implement a touch control function. The sensor may be disposed on the touch control layer 230 in an array. The sensor may be a capacitive sensor, and the sensor may be replaced with a resistive sensor or a sensor which operates in other forms and has a touch control function. The sensor may be formed by a two-layer metal mesh. The fabrication of the metal mesh may require processes, such as metal deposition, exposure, development, etching, stripping, and water cleaning between thereof. It should be noted that the metal mesh may also be replaced with other conductive materials, such as indium tin oxide (ITO). It should be noted that the person skilled in the art may use other processes to form a sensor with touch function as the touch control layer 230.

Referring to FIG. 4, taking the base layer 210 used polyimide for the main material as an example, the base layer 210 is transparent and foldable. The touch control layer 230 disposed on the base layer 210 may foldable with the base layer 210, and the hardened layer 220 is used to protect the base layer 210 from being scratched during the use (such as touching). Therefore, the flexible touch cover 200 can replace the rigid cover plate and the sensing substrate in the prior art. The flexible touch cover 200 can cooperate with the flexible display panel 250, such that the out-cell type flexible touch display panel 300 provided by the present invention is no more restricted by the rigid cover plate and the sensing and is foldable.

In addition, since the touch control layer 230 is not embedded in the flexible display panel 250, but is disposed on the flexible touch cover 200, that means the touch control layer 230 is away from the flexible display panel 250, the out-cell type flexible touch display panel 300 can have excellent anti-interference.

Furthermore, since the flexible touch cover 200 replaces the rigid cover plate and the sensing substrate in the prior art, the thickness occupied by the rigid cover plate and the sensing substrate can be greatly reduced. And the touch control layer 230 can be directly disposed on the base layer 210, reducing the number of the used adhesive layer, so that the thickness of the out-cell type flexible touch display panel 300 of the present invention is greatly reduced.

The beneficial effect: the rigid cover and the sensing substrate in the prior art can be replaced by using the flexible touch cover, such that the out-cell type flexible touch display panel can have excellent anti-interference and foldable properties. In addition, the thickness occupied by the rigid cover and the sensing substrate can be reduced and the number of the used adhesive layer can be reduced, so as to the thickness of the out-cell type flexible touch display panel can be further reduced.

In view of the above, although the present invention has been disclosed by way of preferred embodiments, the above preferred embodiments are not intended to limit the present invention, and one of ordinary skill in the art, without departing from the spirit and scope of the invention, the scope of protection of the present invention is defined by the scope of the claims.

What is claimed is:

1. A flexible touch cover for an out-cell type flexible touch display panel, comprising:
a base layer having a first surface and a second surface opposite to the first surface, the base layer comprising polyimide;
a hardened layer disposed on the first surface; and
a touch control layer disposed on the second surface.

2. The flexible touch cover according to claim 1, wherein the touch control layer comprises at least one sensor.

3. The flexible touch cover according to claim 1, wherein the flexible touch cover further comprises an adhesive layer configured to fixedly assemble the flexible touch cover in the out-cell type flexible touch display panel.

4. The flexible touch cover according to claim 1, wherein the hardened layer comprises a resin material.

5. The flexible touch cover according to claim 1, wherein the hardened layer comprises silicon dioxide or titanium dioxide.

6. A flexible touch cover for an out-cell type flexible touch display panel, comprising:
a base layer having a first surface and a second surface opposite to the first surface;
a hardened layer disposed on the first surface; and
a touch control layer disposed on the second surface.

7. The flexible touch cover according to claim 6, wherein the base layer is transparent and foldable.

8. The flexible touch cover according to claim 7, wherein the base layer comprises polyimide.

9. The flexible touch cover according to claim 6, wherein the touch control layer comprises at least one sensor.

10. The flexible touch cover according to claim 6, wherein the flexible touch cover further comprises an adhesive layer configured to fixedly assemble the flexible touch cover in the out-cell type flexible touch display panel.

11. The flexible touch cover according to claim 6, wherein the hardened layer comprises a resin material.

12. The flexible touch cover according to claim 6, wherein the hardened layer comprises silicon dioxide or titanium dioxide.

13. An out-cell type flexible touch display panel, comprising:
a flexible display panel;
an adhesive layer disposed on the flexible display panel; and
a flexible touch cover disposed on the adhesive layer, the flexible touch cover fixedly assembled with the flexible display panel by the adhesive layer, wherein the flexible touch panel comprises:
a base layer having a first surface and a second surface opposite to the first surface;
a hardened layer disposed on the first surface away from the flexible display panel; and
a touch control layer disposed on the second surface facing the flexible display panel.

14. The out-cell type flexible touch display panel according to claim 13, wherein the base layer is transparent and foldable.

15. The out-cell type flexible touch display panel according to claim 14, wherein the base layer comprises polyimide.

16. The out-cell type flexible touch display panel according to claim 13, wherein the touch control layer is adjacent to the adhesive layer, such that the flexible touch cover is fixed on the flexible display panel.

17. The out-cell type flexible touch display panel according to claim 13, wherein the hardened layer is configured to protect the base layer from being scratched.

18. The out-cell type flexible touch display panel according to claim 17, wherein the hardened layer comprises a resin material.

19. The out-cell type flexible touch display panel according to claim 17, wherein the hardened layer comprises silicon dioxide or titanium dioxide.

20. The out-cell type flexible touch display panel according to claim 13, wherein the touch control layer comprises at least one sensor.
